(19) United States
(12) Patent Application Publication
(10) Pub. No.: US 2005/0212428 A1
(43) Pub. Date: Sep. 29, 2005

(54) Plasma display panel

(75) Inventor: Toshihiro Yoshioka, Izumi (JP)

Correspondence Address: MCGINN & GIBB, PLLC, 8321 OLD COURTHOUSE ROAD, SUITE 200, VIENNA, VA, 22182-3817, US

(73) Assignee: Pioneer Plasma Display Corporation, Izumi (JP)

(21) Appl. No.: 11/086,999

(22) Filed: Mar. 23, 2005

(30) Foreign Application Priority Data
Mar. 24, 2004 (JP) 2004-088132

(51) Int. Cl. H01J 17/49

(52) U.S. Cl. 313/584; 313/585; 313/583

(57) ABSTRACT

The front substrate of the PDP includes a scanning electrode and a sustain electrode, a dielectric layer (not shown) that covers these electrodes, and a protective layer (not shown) that protects the dielectric layer from discharge. The scanning electrode and the sustain electrode each includes a floating-state transparent electrode of a transparent conductive material divided into several pieces, a branch electrode capacitively coupled with these transparent electrode pieces, and a bus electrode directly connected to the branch electrode, so that a pair of gas discharge electrodes is formed to be opposite to each other via a surface discharge gap. The transparent electrode includes four electrode pieces of the same dimensions, and the branch electrodes are separated from the discharge gas space by barrier ribs on the rear substrate. The present invention improves light emission efficiency of a PDP formed by AC-type discharge cells.

### BACKGROUND OF THE INVENTION

1. Field of the Invention

The present invention relates to a plasma display panel (hereinafter referred to as a PDP), and more particularly to a PDP that can improve light emission characteristics and decrease power consumption.

2. Description of the Related Art

PDPs are categorized into an AC-type PDP and a DC-type PDP depending on their operation method. The AC-type PDPs are widely used because they make it possible to readily achieve larger screens with a relatively simple structure. The AC-type PDPs share a basic structure which includes a front substrate (first substrate) and a rear substrate (second substrate) facing each other so as to form a discharge gas space for generating plasma therebetween. The front substrate and the rear substrate are both made of transparent material such as glass. Among PDPs having this basic structure, a so-called AC-type 3-electrode surface discharge PDP is most widely used, which has a pair of row-electrodes as display electrodes consisting of a scanning electrode and a sustain electrode (or common electrode) disposed parallel to each other in a horizontal (row) direction on the inside face of the front substrate that is one of the paired substrates forming the discharge cell, and a column-electrode as a data electrode (address electrode) arranged in a vertical (column) direction orthogonal to the row-electrodes on the inside face of the rear substrate that is the other of the paired substrates. The reason for the wider use of the AC-type 3-electrode surface discharge PDP is its longer life due to no strike on a phosphor layer formed on the inner surface of the rear substrate by high-energy ions produced on the front substrate during surface discharge. Red, green and blue phosphor layers are provided on the inner surface of the rear substrate of the AC-type 3-electrode surface discharge PDP, thus making it possible to emit multi-colored light.

FIG. 19 is an exploded perspective view showing a schematic structure of a conventional AC-type 3-electrode surface discharge PDP as described above. FIG. 20 is a cross-sectional view taken through line V₁-V₁ in FIG. 19, and FIG. 21 is a cross-sectional view taken through line W₁-W₁ in FIG. 19. The PDP 100, as shown in FIGS. 19-21, has the basic structure including a front substrate 101 and a rear substrate 102 facing each other so as to form a discharge gas space 103 between the two substrates 101 and 102.

The front substrate 101 includes a first insulating substrate 104 made of transparent material such as glass, a pair of row electrodes having a scanning electrode 105 and a sustain electrode 106 disposed parallel to each other in a row direction H and opposed each other with a surface discharge gap 107 provided therebetween on the inner face of the first insulating substrate 104, a dielectric layer 108 covering the scanning electrode 105 and the sustain electrode 106, and a protective layer 109 that protects the dielectric layer 108 from discharge. The scanning electrode 105 is formed by a transparent electrode 105A (gas discharge electrode) and a bus electrode 105B, while the sustain electrode 106 is formed by a transparent electrode 106A (gas discharge electrode) and a bus electrode 106B.

The rear substrate 102, on the other hand, includes a second insulating substrate 111 made of transparent material such as glass, a data electrode 112 as a column electrode disposed in a column direction V orthogonal to the row direction H on the inner face of the second insulating substrate 111, a dielectric layer 113 that covers the data electrode 112, barrier ribs 114 formed along the column direction V in order to separate each discharge cell as well as establishing the abovementioned gas discharge space 103, and a phosphor layer 115 overlaying the bottom and inner walls of the barrier ribs 114 The phosphor layer 115 includes a red phosphor layer 115R, a green phosphor layer 115G, and a blue phosphor layer 115B. A reference numeral 110 denotes a unit discharge cell (hereinafter referred to simply as a cell). A non-discharging gap 116 is provided between adjacent unit discharge cells in the column direction V so as not to cause discharge therebetween. The above-described scanning electrode 105, the sustain electrode 106, and the data electrode 112 together form the three electrodes mentioned above, while three unit discharge cells 100 respectively including the three phosphor layers 115R, 115G and 115B form a pixel of the screen. A plurality of pixels are arranged in a matrix pattern, i.e., arranged in the row direction H and the column direction V so as to form the PDP 100 (See for example Japanese Patent Kokai No. 2003-068212, Paragraphs 0010-0011 and FIG. 1).

In a basic operation of the PDP described above, in order to select a unit discharge cell 110 to be displayed (light emitted), writing discharge is carried out by applying a data pulse to the data electrode 112 on the rear substrate 102, as well as applying a scanning pulse to the scanning electrodes 105 on the front substrate 101. A sustain (display) discharge or the surface discharge is then carried out in the selected cell by applying bipolar voltage between the scanning electrode 105 and the sustain electrode 106. Then vacuum ultraviolet light (VUV light) produced by this discharge irradiates the abovementioned phosphor layer, and causes it to emit red, green and blue visible light.

The most important factor to improve the light emission efficiency of the cells within the AC-type 3-electrode PDP described above is ensuring efficient production of the VUV light from the discharge gas including an inert gas such as neon (Ne) or xenon (Xe) within the cells with respect to electric power applied between the bus electrode 105B and bus electrode 106B. To this end, it is necessary to provide a structure that reduces the kinetic energy of the electrons as low as possible that is produced by the discharge (the ionization of the discharge gas is decreased), and increases the excitation efficiency (also referred to as the excitation cross section) of the discharge gas used to produce VUV light.

Effective ways of achieving this might include increasing the thickness of the dielectric layer that covers the gas discharge electrodes (the transparent electrodes 105A and 106A), or forming the dielectric layer with material having low relative dielectric constant so as to reduce the electrostatic capacity produced by the dielectric layer between the gas discharge electrodes and the discharge gas space. However, the dielectric layer with lower electrostatic capacity increases voltage necessary to start the discharge, and thus increases the operating voltage between the discharge electrodes. This leads to a problem that the power consumption of the PDP drive circuit is increased. The discharge voltage necessary to start the discharge becomes more prominent when the gas pressure of the discharge gas is increased.

One effective approach to solve this problem is to use a bipolar voltage for the voltage applied between the bus electrodes 105B and 106B. Specifically, a voltage applied to the bus electrode is set at high voltage level when starting the discharge, and set at low voltage level during sustain discharge. However this leads to a problem that a more complicated circuit structure for driving the PDP is required to produce the voltage waveform described above and thus cost of the PDP is increased.

Another possible approach might be employing a discharge method which uses a floating electrode for at least one of the electrodes of the AC-type surface discharge electrodes. However, in this case, discharge occurs through a part of the floating electrode, so that the discharge becomes localized and does not spread satisfactorily throughout the cell. Accordingly, the light emission efficiency of the cell is reduced. Localization of the discharge becomes more prominent when the pressure of the discharge gas is increased.

### SUMMARY OF THE INVENTION

An object of the present invention is to provide a plasma display panel that can readily improve the light emitting efficiency of the cells and decrease the power consumption for driving the PDP formed by AC-type discharge cells.

Another object of the present invention is to provide a plasma display panel that can prevent a localized discharge and stably expand the discharge area.

According to one aspect of the present invention, there is provided a plasma display panel including a first substrate having a gas discharge electrode for display covered with dielectric layer so as to form display cells arranged in rows and columns within a display area, and a bus electrode arranged in a row direction for supplying electric power to the discharge electrode, and a second substrate provided to face the first substrate with a discharge gas space formed therebetween, having a barrier rib that divides the display cells within the display area and an address electrode arranged in a column direction. The gas discharge electrode is divided into electrode pieces on the same plane and at least some of these electrode pieces are individually electrically coupled to the bus electrode through a capacitance insulator or resistor.

The gas discharge electrode may be divided to form the electrode pieces arranged in a column direction.

Two or more of the electrode pieces may be electrically coupled with the bus electrode through the capacitance insulator or resistor.

The gas discharge electrode for display use may be formed by a pair of surface discharge electrodes that carry out gas discharge within the discharge gas space of the display cells.

At least one of the pair of surface discharge electrodes may be divided into electrode pieces.

At least one pair of electrode pieces among the electrode pieces of the surface discharge electrodes may be directly electrically connected to the bus electrode.

The electrode pieces opposite to each other via the surface discharge gap of the pair of surface discharge electrodes may be formed of a transparent conductive material, and are connected in a row direction within the display area.

Some of the electrode pieces may be formed of transparent conductive material.

The electrical coupling between the electrode pieces and the bus electrode may be formed within an area of the display cells where no gas discharge occurs.

The electrical coupling between the electrode pieces and the bus electrode may be formed through a branch electrode linking with the bus electrode and arranged in a position overlapping a pattern of the barrier ribs.

The electric coupling of the electrode pieces and the bus electrode may be formed through a branch electrode formed of a transparent conductive material and connected to the bus electrode.

The capacitance insulator may be provided on a side facing the second substrate of the electrode pieces and the branch electrodes overlap with a part of the electrode pieces via the capacitance insulator.

The capacitance insulator may be provided on a side facing the second substrate of the branch electrode and the electrode pieces are so arranged as to overlap with the branch electrodes via the capacitance insulator.

The capacitance insulator may be made from an oxide or a nitride.

The resistor may be made from a transparent oxide resistance material.

The discharge gas filled in the discharge gas space may include at last one of Xe, Kr, Ar, or N₂, and the partial pressure thereof is 100 hPa or higher.

An electrode piece nearest the bus electrode may be wider than another electrode piece among the plurality of the electrode pieces electrically connected to the bus electrode.

The plurality of the electrode pieces electrically connected to the bus electrode may have the same dimension.

The capacitance insulator may be thinner than the dielectric layer.

The structure of the present invention readily achieves an improvement of light emitting efficiency within the discharge cells as well as reducing the drive current and power consumption within a PDP of an AC-type discharge cell structure. Further, the structure prevents a localized discharge and stably expands the discharge area in the discharge cells. Accordingly, the light emitting efficiency can be remarkably increased by employing high pressure for the discharge gas.

### BRIEF DESCRIPTION OF THE DRAWINGS

FIG. 1 is an exploded perspective view showing the schematic structure of the PDP according to a first embodiment of the present invention;

FIG. 2 is a plan view showing the schematic structure of the PDP shown in FIG. 1;

FIG. 3 is a cross-sectional view taken along a line X₁-X₁ in FIG. 2;

FIG. 4 is a cross-sectional view taken along a line X₂-X₂ in FIG. 2;

FIG. 5 is a cross-sectional view taken along a line Y₁-Y₁ in FIG. 2;

FIGS. 6A and 6B are a voltage waveform chart showing the basic operation of the PDP of the first embodiment and a schematic cross-sectional view of an electrode part for the gas discharge, respectively;

FIGS. 7A and 7B are a voltage waveform chart showing the basic operation of the PDP of the first embodiment and a schematic cross-sectional view of an electrode part for the gas discharge, respectively;

FIG. 8 is a plan view showing the schematic structure of the PDP according to a second embodiment of the present invention;

FIG. 9 is a cross-sectional view taken along a line X₃-X₃ in FIG. 8;

FIG. 10 is a cross-sectional view taken along a line X₄-X₄ in FIG. 8;

FIG. 11 is a cross-sectional view taken along a line Y₂-Y₂ in FIG. 8;

FIG. 12 is plan view showing the schematic structure of the PDP according to a third embodiment of the present invention;

FIG. 13 is a cross-sectional view taken along a line X₅-X₅ in FIG. 12;

FIG. 14 is a cross-sectional view taken along a line X₆-X₆ in FIG. 12;

FIG. 15 is a cross-sectional view taken along a line Y₃-Y₃ in FIG. 12;

FIGS. 16A and 16B are a voltage waveform chart showing the basic operation of the PDP of the third embodiment and a schematic cross-sectional view of an electrode part for the gas discharge, respectively;

FIG. 17 is a plan view showing the schematic structure of a PDP according to a fourth embodiment of the present invention;

FIG. 18 is a plan view showing the schematic structure of another PDP according to a fourth embodiment of the present invention;

FIG. 19 is an exploded perspective view showing the schematic structure of a conventional PDP;

FIG. 20 is a cross-sectional view taken along a line V₁-V₁ in FIG. 19; and

FIG. 21 is a cross-sectional view taken along a line W₁-W₁ in FIG. 19.

### DETAILED DESCRIPTION OF THE INVENTION

Embodiments of the present invention will be hereinafter described concretely with reference to the accompanying drawings.

### First Embodiment

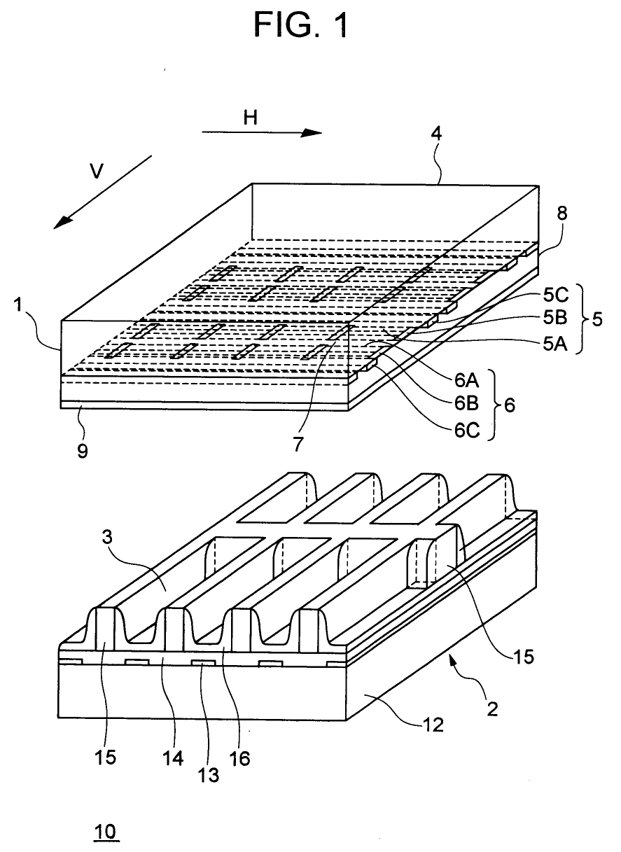

As shown in FIG. 1 through FIG. 5, a PDP of this embodiment has a basic structure including a front substrate (first substrate) 1 and a rear substrate (second substrate) 2 facing each other so as to form a discharge gas space 3 between the first and second substrates 1 and 2.

The front substrate 1 includes a first insulating substrate 4 made of transparent material such as soda-lime glass, a scanning electrode 5 and a sustain electrode (or common electrode) 6 forming a pair of row electrodes arranged parallel to each other in a row (horizontal) direction H and opposed each other with the surface discharge gap 7 provided therebetween on the inner face of the insulating substrate 4, a dielectric layer 8 of 10 μm-50 μm in layer thickness made of flit glass containing zinc, flit glass containing lead or the like that covers the scanning electrode 5 and the sustain electrode 6, and a protective layer 9 made of MgO (magnesium oxide) or the like to protect the dielectric layer 8 from electrical discharge. The scanning electrode 5 and the sustain electrode 6 include floating-state transparent electrode pieces 5A, 6A made of transparent conductive material such as ITO (Indium Tin Oxide) or Tin Oxide (SnO₂), and divided into several pieces, branch electrodes 5B, 6B capacitively coupled with the transparent electrodes 5A, 6A, and bus electrodes 5C, 6C made of a low-resistance metal such as Al (aluminum), Cu (copper), or Ag (silver) and connected to the branch electrodes 5B, 6B. The transparent electrode piece 5A includes four electrode pieces having the same dimensions, i.e., transparent electrode pieces 5A1, 5A2, 5A3 and 5A4. Similarly, the transparent electrode piece 6A includes four electrode pieces having the same dimensions, i.e., transparent electrode pieces 6A1, 6A2, 6A3 and 6A4. These transparent electrode pieces 5A and 6A form the gas discharge electrodes.

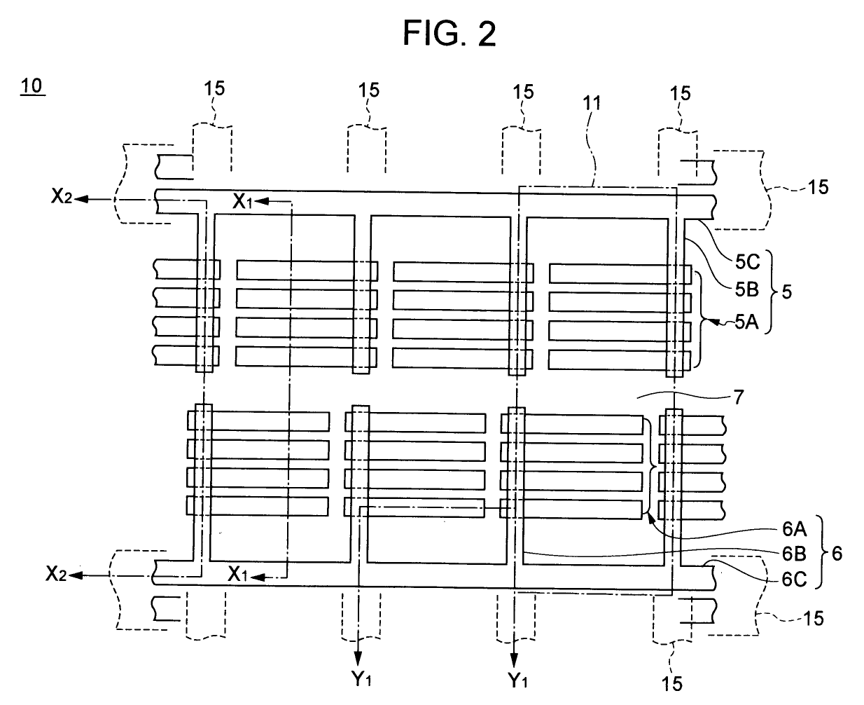

The rear substrate 2, on the other hand, includes a second insulating substrate 12 made of transparent material such as soda-lime glass, a data electrode (address electrode) 13 disposed in a column (vertical) direction V orthogonal to the row (horizontal) direction H on the inner face of the second substrate 12 and made of Al, Cu, Ag, or the like, a dielectric layer 14 made of flit glass containing zinc, flit glass containing lead or the like and covering the data electrode 13, barrier ribs 15 made of flit glass containing lead or the like provided along the row direction H and the column direction V in order to divide each discharge cell as well as establishing the discharge gas space 3 filled with a discharge gas such as Xe, Kr (krypton), Ar (argon), N₂ (nitrogen) or the like, or mixed gas thereof, and a phosphor layer 16 that covers the bottom and side walls of the barrier ribs 15 so as to convert the ultraviolet light produced by the discharge of the discharge gas into visible light. The phosphor layer 16 is divided into a red phosphor layer 16R made of (Y, Ga) BO₃:Eu or the like, a green phosphor layer 16G made of Zn₂SiO₄:Mn or the like, and a blue phosphor layer 16B made of BaMgAl₁₄O₂₃:Eu or the like. The reference numeral 11 in FIG. 2 denotes a unit discharge cell (hereinafter referred to simply as a cell), and the branch electrodes 5B and 6B are formed on top of the barrier ribs 15. The bus electrodes 5C and 6C are also provided on top of the barrier ribs 15.

The above-described scanning electrode 5, the sustain electrode 6, and the data electrode 13 together form the three electrodes mentioned above, while three unit discharge cells 11 including the three phosphor layers 16R, 16G and 16B together form one pixel of the screen. One pixel of a color PDP of this type corresponds to three pixels of a monochrome PDP. A plurality of these pixels are arranged in a matrix pattern, i.e., arranged along the row direction H and the column direction V, so as to form the PDP.

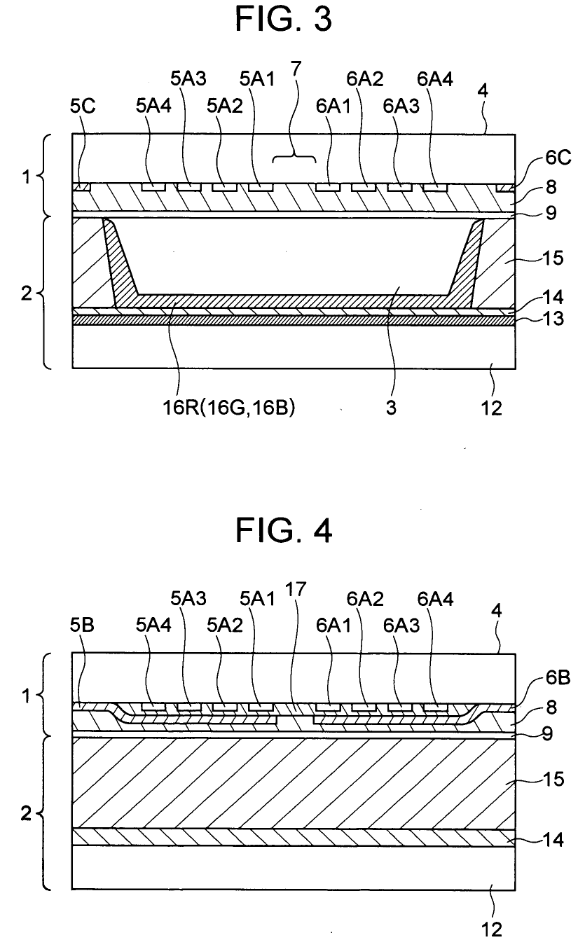

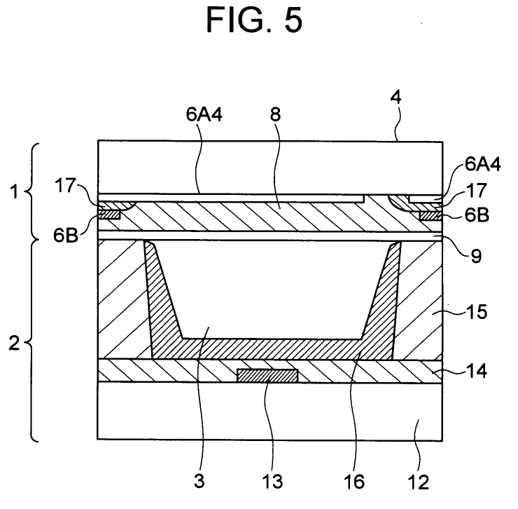

As shown in FIG. 3, the discharge within the gas discharge space 3 initially occurs between the divided transparent electrode pieces 5A1 and 6A1 that are separated by the surface discharge gap 7, which is explained below. This discharge then expands towards the bus electrodes 5C and 6C within a few hundred microseconds. As shown in FIG. 4, these divided transparent electrode pieces 5A and 6A are formed to capacitively couple with the branch electrodes 5B and 6B via the capacitance insulator 17. It should be noted that, as shown in FIG. 3 and FIG. 5, the capacitance insulator 17 is not formed on the transparent electrode pieces 5A and 6A that face the gas discharge space 3, and thus the dielectric layer 8 and the protective layer 9 are positioned between the transparent electrode pieces 5A and 6A and the gas discharge space 3. The capacitance insulator 17 is formed by a insulating film of 1 μm-20 μm in film thickness having a high dielectric constant with lead oxide or zinc oxide as its principal ingredients such as low-melting point glass, yttrium oxide, tantalum oxide, silicon nitride or the like. The insulating film is formed to be thinner than the dielectric layer 8. It should be noted that the relative dielectric constant of the capacitance insulator 17 becomes approximately 5-200 after sintering.

The basic operation of the circuit for driving the PDP 10 described above is precisely the same as that already described for the conventional technology. Namely, a writing discharge to select the unit discharge cell 11 to be displayed (light emitted) is carried out by applying a data pulse to the data electrode 13 on the rear substrate 2 while applying a scanning pulse to the bus electrode 5C on the front substrate, and then sustain (display) discharge or surface discharge is carried out on the selected cell by applying bipolar voltage between the scanning electrode 5 and the sustain electrode 6.

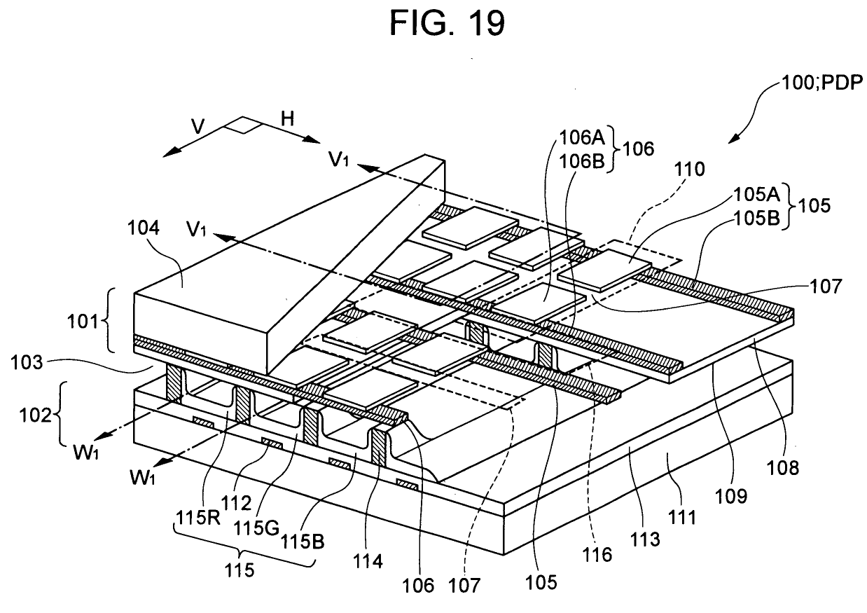

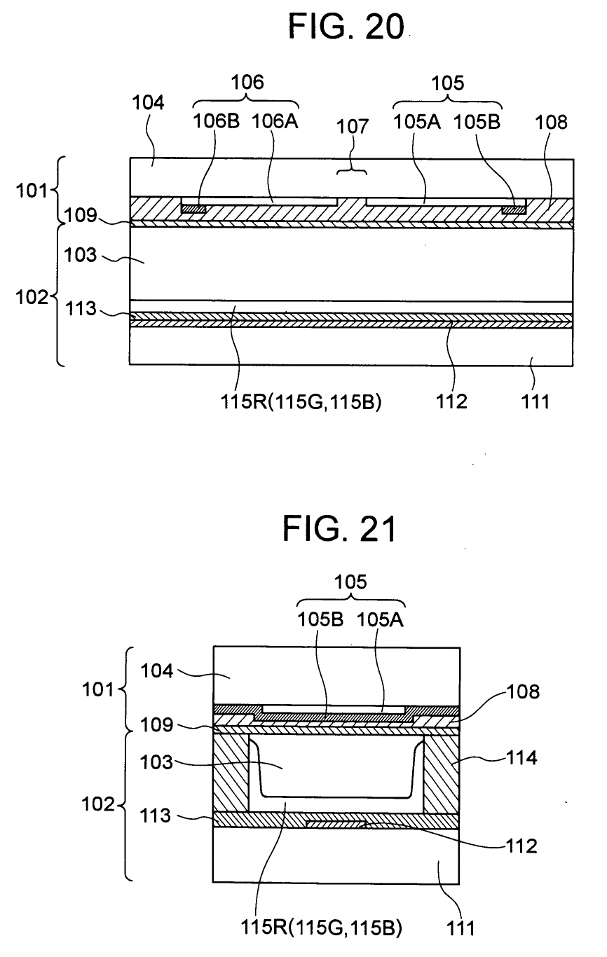

An assessment was carried out by comparing the light emission characteristics and the drive voltage of the PDP 10 according to the first embodiment of the present invention with those of the PDP 100 of the conventional technology as illustrated in FIGS. 19-21. In order to make the effects of the present invention clear, all elements were made identical with respect to their dimensions and materials except for the capacitively coupled floating transparent electrode pieces 5A and 6A that are distinguishing features of the present invention and the transparent electrodes 105A and 106A of the conventional technology. In particular, the dimensions and materials of the gas discharge spaces 3 and 103, the dielectric layers 8 and 108, and the surface discharge gaps 7 and 107 were carefully adjusted so as to be identical to each other.

The results showed that the drive voltage greatly depended on the thickness of the dielectric layers 8 and 108 within the area of the surface discharge gaps 7 and 107. If the materials and the thickness of the dielectric layers 8 and 108 were the same, approximately the same values were obtained. The light emission efficiency, on the other hand, of the PDP 10 according to the present embodiment represented a significant improvement over the conventional technology. This improvement in light emission efficiency was even more striking than that achieved by increasing the thickness of the dielectric layer 108 as described above in the conventional technology. The difference between the present embodiment and the conventional technology became increasingly evident as the pressure of the discharge gas was increased. This difference was especially pronounced when the gas pressure was equal to or higher than 100 hPa.

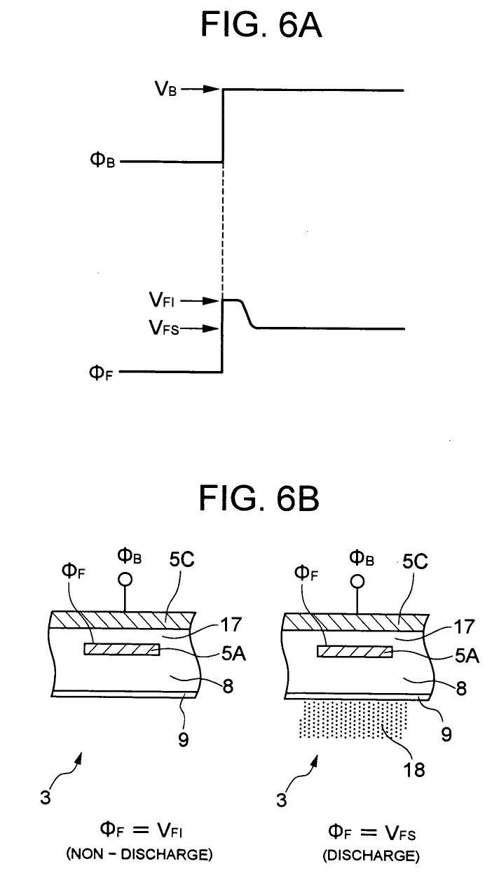

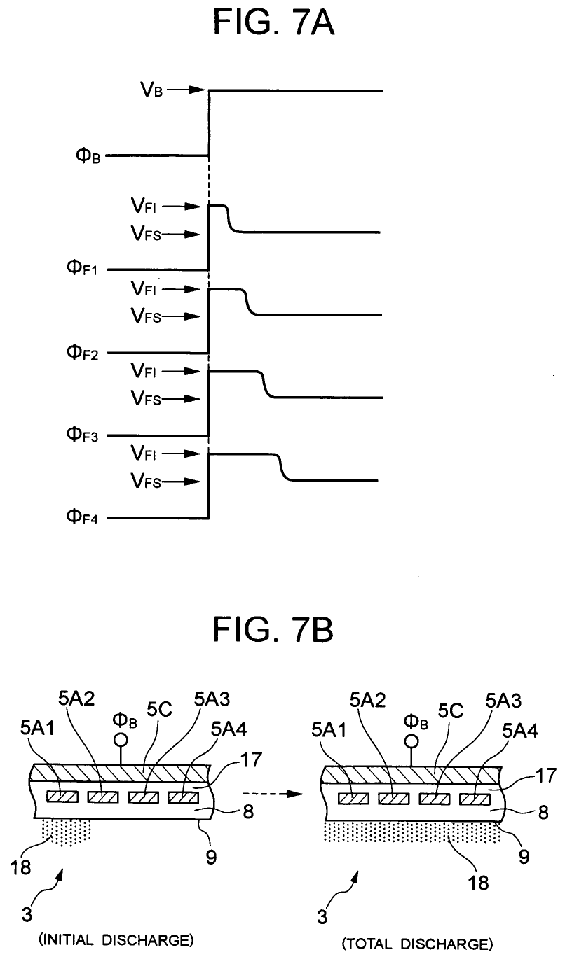

Next, the structure of the embodiment that produced the results described above and the effect of discharge expansion achieved by the embodiment are described with reference to FIGS. 6A, 6B and FIGS. 7A, 7B. FIG. 6A is a schematic chart illustrating transitional changes of the voltage φB applied to the bus electrode 5C when discharge is carried out and the voltage φF produced at the floating transparent electrode piece 5A at the same time. FIG. 6B is a schematic diagram showing a cross-sectional structure of the bus electrode 5C and the gas discharge space 3 during the transitional change described above.

As shown in FIG. 6A, when the voltage V_{B} (for example 150-200V) is applied between the bus electrode 5C of the scanning electrode 5 and the bus electrode 6C of the sustain electrode in order to generate the surface discharge, no significant discharge (glow discharge) is produced in the gas discharge space 3 because it is the non-discharge period as illustrated in FIG. 6B. Then the voltage φF of the transparent electrode piece 5A of the scanning electrode 5 rises to the voltage V_{FI} as shown by φF in FIG. 6A because of capacitance coupling via the capacitance insulator 17. Then the discharge gas within the discharge gas space 3 is ionized and discharge starts by the voltage V_{FI} applied to the transparent electrode piece 5A. When the discharge starts as shown in FIG. 6B, the voltage φF of the transparent electrode piece 5A falls automatically to the level V_{FS}. During a steady state condition where discharge continues within the discharge gas space 3, the voltage φF of the transparent electrode piece 5A is maintained at the level V_{FS}.

A detail of the above-described mechanism is complicated because it is necessary to take into consideration the structure of the plasma 18 produced by the discharge. Therefore, a simplified equivalent circuit is described hereinafter in order to make it easy to qualitatively understand the structure described above. The voltage φF of the floating-state transparent electrode piece 5A within the structure shown in FIG. 6B is expressed in equation 1.

$$Equation 1$$

$$ϕ F = \frac{{C}_{O}}{{C}_{O} + \frac{{C}_{D} - {C}_{V}}{{C}_{D} + {C}_{V}}} ϕ B \qquad ( 1 )$$

Where C_{O} is the capacitance of the capacitance insulator 17, C_{D} is the capacitance of a laminated film of the dielectric layer 8 and the protective layer 9, and C_{V} is the capacitance value from the discharge gas space 3 to the bus electrode 6C of the sustain electrode 6. These capacitances varies depend on the charges that follow changes of the voltage φF, and can be expressed as series of connection between the bus electrodes 5C and 6C. The capacitance C_{O} can be determined by controlling the area of overlap between the branch electrodes 5B, 6B and the transparent electrode pieces 5A, 6A, the film thickness of the capacitance insulator 17, and the relative dielectric constant of the insulating material thereof.

During the non-discharge period mentioned above, there is almost no electrical charge within the discharge gas space 3 and the value C_{V} is small. Accordingly, when equation 2 is approximated by C_{V}<<C_{D}, the value V_{FI} becomes the same as the value V_{B}. In reality the true value V_{FI} is somewhat smaller than the value V_{B}, but nevertheless the value V_{FI} is close to the value V_{B}.

$$Equation 2$$

$${V}_{FI} = \frac{{C}_{O}}{{C}_{O} + \frac{{C}_{V}}{1 + {C}_{V} / {C}_{D}}} {V}_{B} ≅ {V}_{B} \qquad ( 2 )$$

During the discharge, on the other hand, plasma 18 is formed within the discharge gas space 3. The structure of the plasma produced varies depending on the conditions such as pressure of the discharge gas and the applied voltage. For the sake of simplicity, no equivalent circuit of the plasma including the ion sheath and so on is taken into account that is produced on the surface of the dielectric layer 8, and when the electrical potential of the surface of the abovementioned dielectric layer 8 that faces the plasma 18 is assumed to be approximately equal to the ground potential, then the value V_{FS} can be expressed as Equation 3 in which the value V_{FS} is obtained by capacitively dividing the value V_{B} between the capacitance insulator 17 and the dielectric layer 8. In reality the true value V_{FS} is somewhat higher than this value, but nevertheless the value is made to be lower than the value V_{B}.

$$Equation 3$$

$${V}_{FS} = \frac{{C}_{O}}{{C}_{O} + \frac{{C}_{O}}{{C}_{D} / {C}_{V} + 1}} {V}_{B} ≅ \frac{{C}_{O}}{{C}_{O} + {C}_{D}} VB \qquad ( 3 )$$

As described above, in the present embodiment a high voltage is applied to the transparent electrode piece 5A when discharge is begun, but once discharge has started the voltage of the transparent electrode piece 5A falls automatically, the electric field on the ion sheath within the discharge gas space 3 decreases, and the energy of the electrons within this field is optimized so as to improve their excitation efficiency. Thus the excitation efficiency of the VUV light production improves and the light emission efficiency increases.

In the present embodiment, the expansion of the electrical discharge is brought about by the divided transparent electrode pieces, as shown in FIG. 7A and FIG. 7B. FIG. 7A is a schematic chart illustrating transitional changes of the voltage φB applied to the bus electrode 5C at the time of discharge and the voltages φF1, φF2, φF3, and φF4 produced at the four floating-state electrode pieces 5A1, 5A2, 5A3, and 5A4 at the same time. FIG. 7B, on the other hand, is a schematic diagram showing a cross-sectional structure of the bus electrode 5C and the discharge gas space 3 during the transitional change mentioned above.

When the voltage V_{B} is applied between the bus electrode 5C of the scanning electrode 5 and the bus electrode 6C of the sustain electrode 6, no discharge (glow discharge) has yet been produced within the discharge gas space 3, because it is still the non-discharge period as explained above in FIG. 6B. Then the voltages φF1, φF2, φF3, and φF4 of the four transparent electrode pieces 5A1-5A4 of the scanning electrode 5 all rise to voltage V_{FI} by capacitive coupling via the capacitance insulator 17, as shown in FIG. 7A. Then, the discharge gas positioned below the transparent electrode piece 5A1 that is the nearest piece from the sustain electrode 6 mentioned above within the discharge gas space 3 is initially ionized as a result of the voltage V_{FI} applied on the piece 5A1, and thus the plasma 18 is produced in this area. This corresponds to the early discharge stage shown in FIG. 7B. When the plasma 18 is produced by this discharge, the voltage φF1 of the transparent electrode piece 5A1 falls to the value V_{FS}, as described by FIGS. 6A and 6B and the equations shown above. During a steady state condition where discharge occurs within the discharge gas space 3, the voltage φF1 of the transparent electrode piece 5A1 is maintained at the level V_{FS}.

The discharge gas positioned below the transparent electrode piece 5A2 within the discharge gas space 3 is then ionized as a result of the voltage V_{FI} on the transparent electrode piece 5A2, and plasma is produced in this area. The voltage φF2 of the transparent electrode piece 5A2 falls to the value V_{FS} as exactly the similar manner with the voltage fall of the transparent electrode piece 5A1 described above, and during a steady state condition where discharge occurs within the discharge gas space 3, the voltage φF2 of the transparent electrode piece 5A2 is maintained at the level V_{FS}. Similar voltage changes then take place consecutively for the voltages φF3 and φF4 of the transparent electrode pieces 5A3 and 5A4. During the full-discharge period, as shown in FIG. 7B, the entire desired area within the discharge gas space 3 becomes the discharge state.

In this way, the transitional changes in voltage produced in each of the four floating-state transparent electrode pieces 5A1-5A4 take place independently under the discharge condition of the discharge gas space 3 that is positioned below each electrode piece. For this reason, it is very easy to expand discharge within the discharge gas space 3. Further, the higher the pressure of the discharge gas, the more pronounced this effect becomes. When the transparent electrode pieces 5A is one single floating electrode without having divided pieces, discharge would occur through a nearest part of the floating electrode from the sustain electrode 6, as stated in the above-described description about the problem of the conventional technology. This discharge causes a voltage drop of the entire floating electrode, and thus the discharge does not spread sufficiently throughout the discharge gas space 3, thereby causing localized discharge. This results in a decrease of the light-emission efficiency of the cell. The localized discharge becomes more pronounced when the pressure of the discharge gas is increased.

In the first embodiment described above, the transparent electrode pieces 5A, 6A were formed by four electrode pieces of the same shape, but the number and shape of these electrode pieces may be changed to various alternatives.

### Second Embodiment

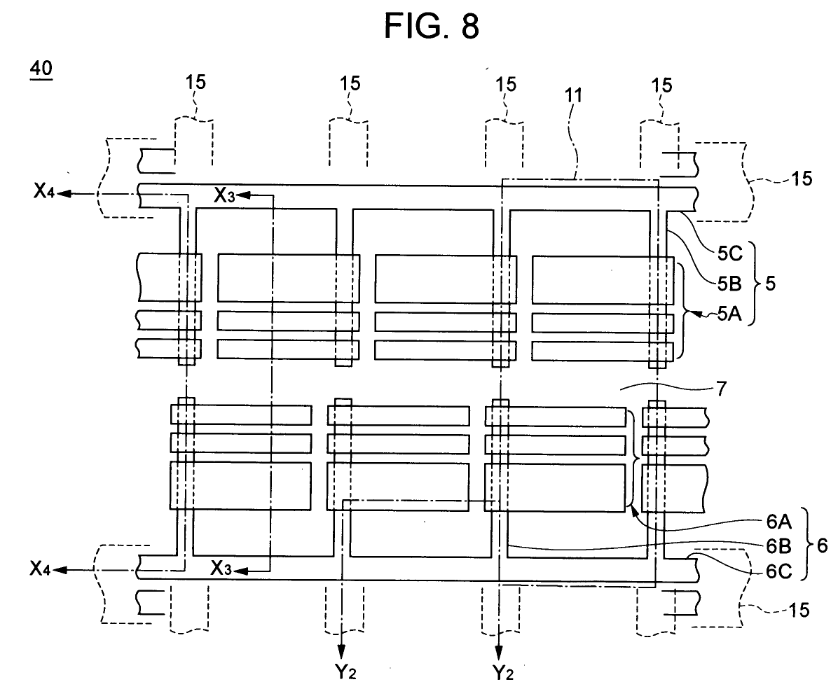

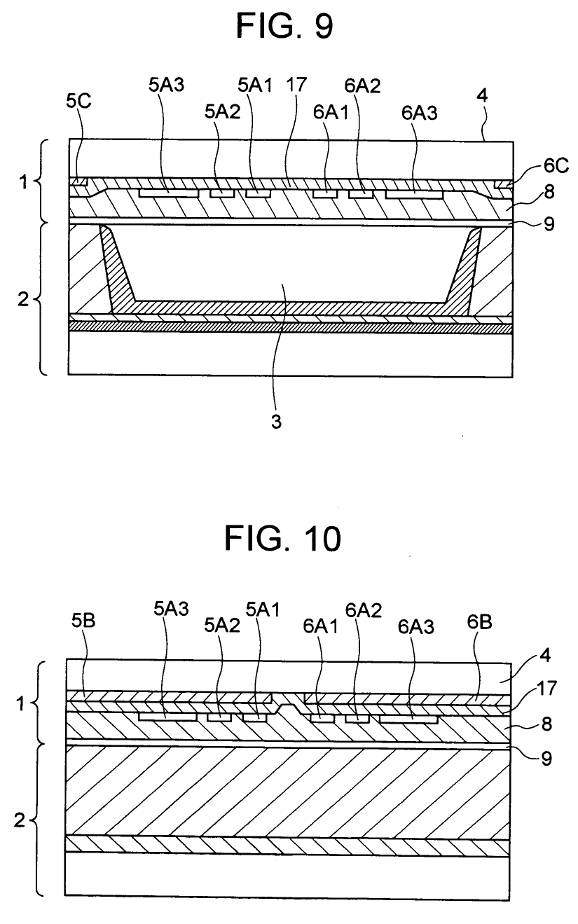

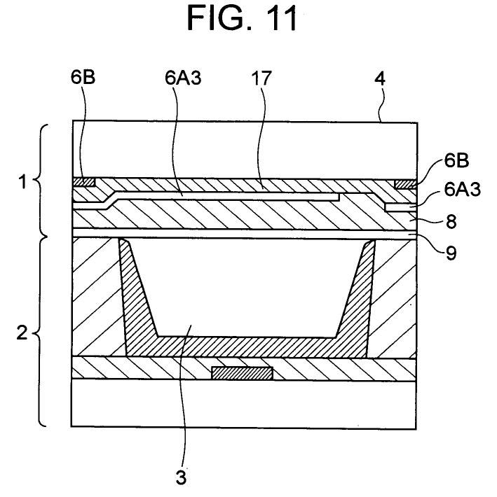

FIG. 8 is a plan view showing the schematic structure of a PDP according to a second embodiment of the present invention. FIG. 9 is a cross-sectional view taken along a line X₃-X₃ in FIG. 8. FIG. 10 is a cross-sectional view taken along a line X₄-X₄ in FIG. 8. FIG. 11 is a cross-sectional view taken along a line Y₂-Y₂ in FIG. 8. Any elements that are the same as those described in FIGS. 1-5 are designated by the same reference numerals. This embodiment differs from the first embodiment in that the capacitance insulator 17 is provided over the branch electrodes 5B, 6B, and the transparent electrode pieces 5A, 6A are laminated over the capacitance insulator 17 (viewed from the discharge gas space 3). This structure, explained in detail below, makes it easy to control the film thickness of the capacitance insulator 17, enabling highly precise control of the capacitance C_{O} of the capacitance insulator 17 and capacitance C_{D} of the dielectric layer 8 on the surface of the PDP, making it possible to achieve stable discharge with a small fluctuation across the surface. Features of the second embodiment that differ from those of the first embodiment will mainly described below. It should be noted that the rear substrate 2 has exactly the same structure as that of the first embodiment.

As shown in FIGS. 8-11, the PDP 20 according to the present embodiment has the basic structure that is similar to the first embodiment, including a front substrate 1 and a rear substrate 2 facing each other so as to form a discharge gas space 3 provided between the two substrates 1 and 2.

Similar to the first embodiment, the bus electrodes 5C, 6C made of a low-resistance metal such as Al, Cu, or Ag and the branch electrodes 5B, 6B made of the same material and connected to the bus electrodes are provided on the surface of the first insulating substrate 4 made of transparent material such as glass. A capacitance insulator 17 is then formed by an insulating film of 0.2 μm-5 μm in film thickness such as silicon oxide film, silicon nitride film or tantalum nitride film so as to cover whole surface of the first insulating substrate by means of the Plasma Enhanced Chemical Vapor Deposition process (PECVD) of a reactant gas.

Then a specified number and a specified shape of transparent electrode pieces 5A, 6A are provided on the surface of this capacitance insulator 17. In FIGS. 8-11 three transparent electrode pieces, i.e., 5A1, 5A2, 5A3 and 6A1, 6A2, 6A3, are provided in each electrode. The dielectric layer 8 and the protective layer 9 are laminated onto the transparent electrode pieces 5A, 6A. The dielectric layer 8, which is the same as that of the first embodiment, is formed of a low-melting point glass of 10 μm-50 μm in film thickness by means of screen-printing process or other method such as the die coating process or blade coating process. It should be noted that the relative dielectric constant of this dielectric layer 8 becomes approximately 5-20 after sintering.

With the arrangement of the PDP 20 according to the second embodiment, the capacitance insulator 17 can be easily formed over the entire surface of the first insulating substrate 4 by means of the PECVD process or the like. Because of this, it is easy to control the film thickness, and it is possible to set the capacitance C_{O} with a high degree of precision. The dielectric layer 8 is also formed by the screen printing process, and the capacitance CD may also be set with a high degree of precision. As can be understood from the description regarding the structure shown in FIGS. 6A, 6B and FIGS. 7A, 7B of the first embodiment, the voltage of the transparent electrodes 5A and 6A during the discharge start period and the discharge period can be produced as planned with a high degree of precision within the discharge gas space 3, making it possible to achieve stable operation with a small fluctuation for driving the PDP.

In the second embodiment described above, the widths of the transparent electrode pieces 5A3 and 6A3 that are closest to the bus electrodes 5C and 6C are made larger than those of the other transparent electrode pieces 5A1, 5A2, and 6A1, 6A2. With this arrangement, no expansion of discharge occurs to the discharge gas space 3 positioned below the bus electrodes 5C, 6C within the unit discharge cell 11, so that no discharge occurs between the adjacent bus electrodes 5C and 6C without having a barrier rib 15 in the area of the bus electrodes 5C and 6C covered with the capacitance insulator 17 and the dielectric layer B. Absence of the barrier rib 15 makes it easy to fabricate the PDP according to the second embodiment, and thus reduces the manufacturing cost.

As mentioned in the first embodiment, the number and shape of the electrode pieces of the second embodiment described above may be changed as necessary.

### Third Embodiment

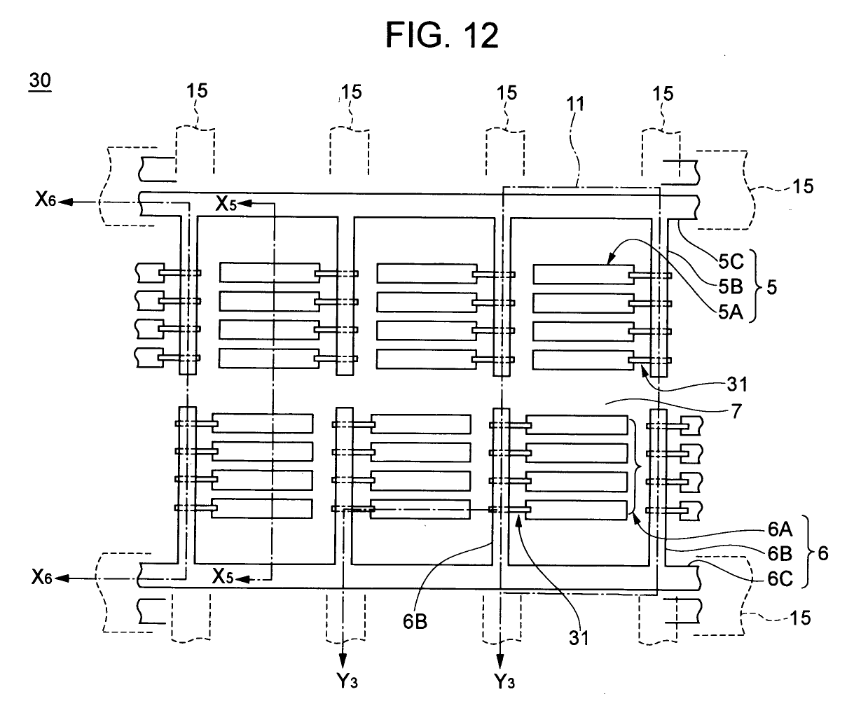

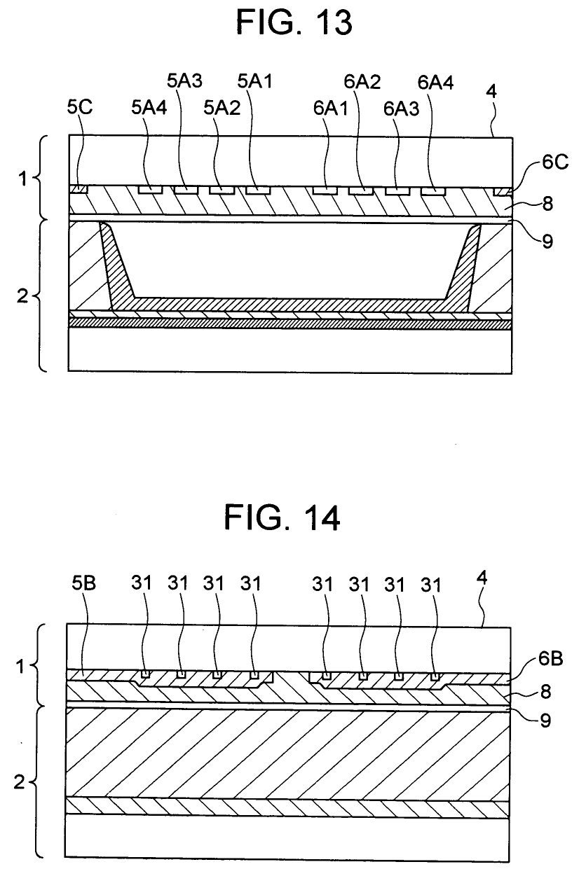

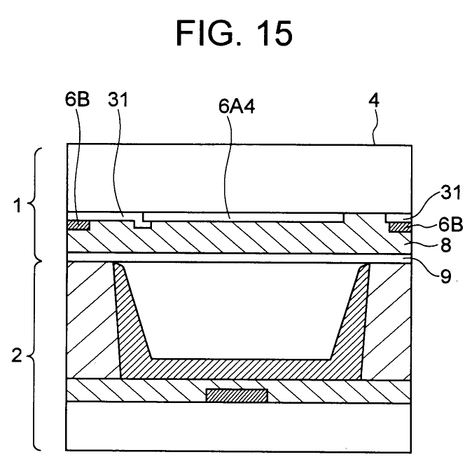

FIG. 12 is a plan view showing the schematic structure of the PDP according to a third embodiment of the present invention. FIG. 13 is a cross-sectional view taken along a line X₅-X₅ in FIG. 12. FIG. 14 is a cross-sectional view taken along a line X₆-X₆ in FIG. 12. FIG. 15 is a cross-sectional view taken along a line Y₃-Y₃ in FIG. 12. Any elements of the present embodiment that are the same as those in FIGS. 1-5 are designated by the same reference numerals. The structure of the present embodiment differs from that of the first and second embodiments in that floating-state transparent electrode pieces 5A, 6A (gas discharge electrodes) formed to have divided pieces of transparent conductive material are individually connected to the branch electrodes 5B and 6B through resistors 31. The structure of this PDP improves the light emission efficiency of the PDP that is similar to the first and second embodiments, which will be hereinafter described in detail. Features of the third embodiment that differ from those of the first and second embodiments will be mainly described below. It should be noted that the rear substrate 2 has exactly the same structure as those of the first and second embodiments.

As shown in FIGS. 12-15, the PDP 30 according to the present embodiment has the basic structure similar to the first embodiment, including a front substrate 1 and a rear substrate 2 facing each other so as to form a discharge gas space 3 provided between the two substrates 1 and 2.

Similar to the first and second embodiments, transparent electrode pieces 5A and 6A including electrode pieces 5A1, 5A2, 5A3, 5A4 and 6A1, 6A2, 6A3, 6A4 are arranged on the surface of a first insulating substrate 4 made of transparent material such as glass. The bus electrodes 5C and 6C made of a low resistance material and the branch electrodes 5B, 6B connected thereto are formed. The branch electrodes 5B and 6B are respectively electrically connected to the transparent electrode pieces 5A and 6A through the resistors 31. The capacitance insulator 31 is formed by a high-resistance material using a transparent oxide resistance material or the like. The dielectric layer 8 and the protective layer 9 are disposed so as to cover the entire surface of the first insulating substrate 4.

In the third embodiment, the voltage φF of the transparent electrode pieces 5A and 6A decreases while discharge continues within the discharge gas space 3 which is similar to the above embodiment. The electrical field within the discharge gas space 3 decreases and the energy of the electrons therein is optimized so as to increase their excitation efficiency. The excitability efficiency of the VUV light production improves, and the light emission efficiency increases.

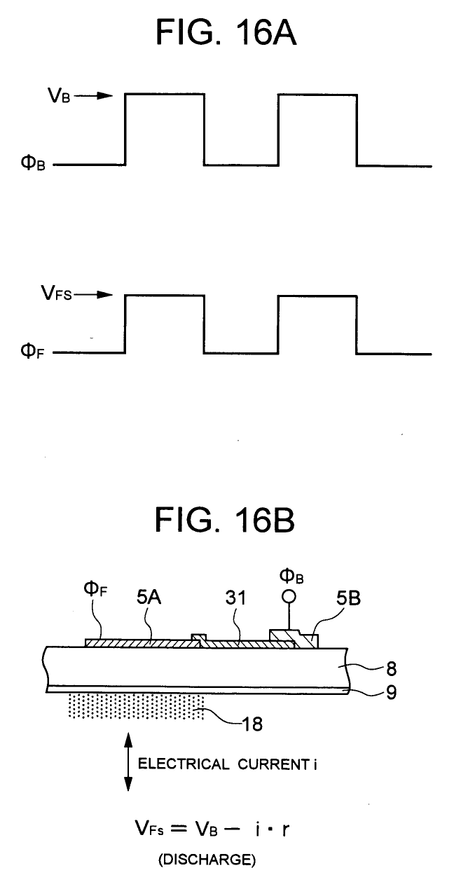

A mechanism of the third embodiment that causes the effect will be described with reference to FIGS. 16A and 16B. FIG. 16A is a schematic chart illustrating the changes of an AC voltage φB applied to the bus electrode 5C when discharge is taking place and a voltage φF produced in the floating-state transparent electrode piece 5A at the same time under the steady state condition. FIG. 16B shows a schematic diagram showing a cross-sectional structure of the scanning electrode 5 and the discharge gas space 3 in the abovementioned discharge state.

As shown in FIG. 16A, when an AC voltage ΦB is applied between the bus electrode 5C of the scanning electrode and the bus electrode 6C of the sustain electrode (for example, at 100 kHz, VB is between 150V and 200V), and discharge takes place and plasma 18 is formed within the discharge gas space 3 as shown in FIG. 16B, an alternating current i flows within the plasma 18. In addition, the alternating current i flows in the resistor 31. Because of this, a voltage drop takes place and the amplitude voltage V_{FS} of the AC voltage φF in the transparent electrode piece 5A becomes smaller than the value VB mentioned above by a value i×r, where r denotes the resistance of the resistor 31. Accordingly, as mentioned above, the electrical field on the ion sheath within the discharge gas space 3 decreases, the kinetic energy of the electrons therein falls, the excitation efficiency of the VUV light production improves, and the light emitting efficiency increases.

As mentioned in the first and second embodiments, the number and shape of the electrode pieces of the third embodiment described above may be changed as necessary.

### Fourth Embodiment

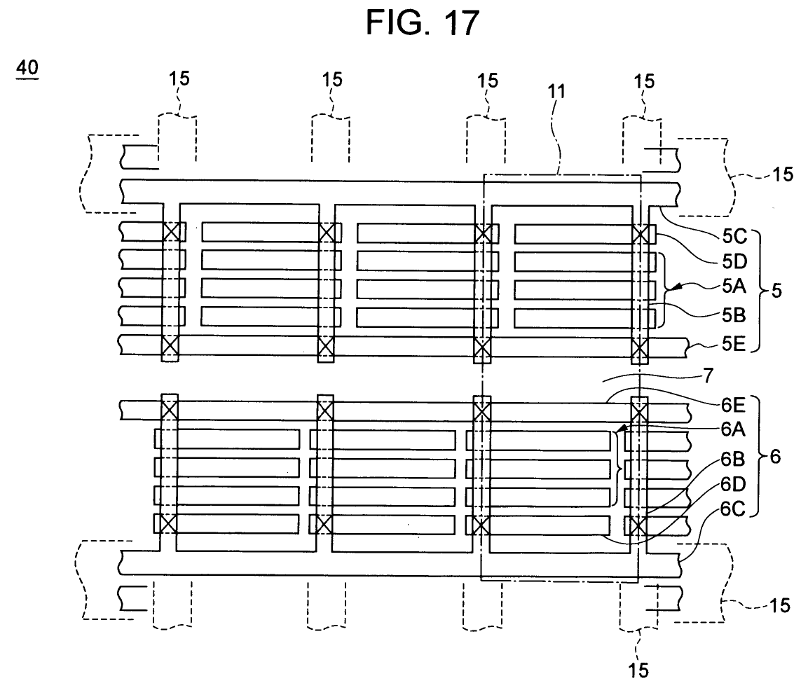

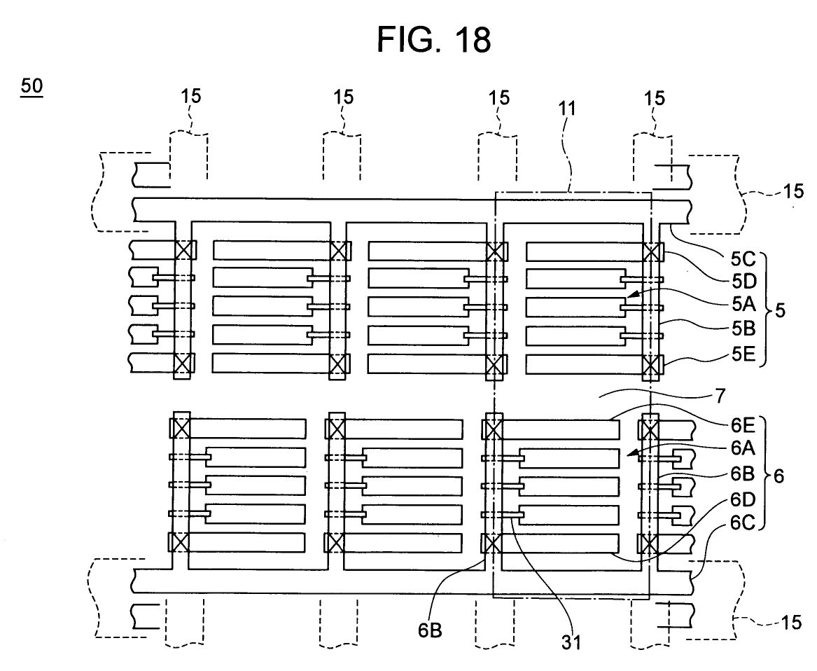

FIGS. 17 and 18 are plan views showing the schematic structure of a PDP according to a fourth embodiment of the present invention. Any elements that are the same as those in the figures referred to in the first, second, and third embodiments above are shown with the same reference numerals. In this embodiment, the scanning electrode 5 and the sustain electrode 6 of the PDP have structures that combine the transparent electrode pieces of the first, second, and third embodiments with the transparent electrodes of the prior art. With this arrangement, the details of which are described below, the stability of the discharge is further improved in addition to the effects brought about in first, second, and third embodiments. Features of the fourth embodiment that differ from those of the embodiments 1 through 3 will be mainly described below. It should be noted that structures other than the scanning electrode 5 and the sustain electrode 6 are the same as those of the first, second, and third embodiments.

As shown in FIG. 17, the PDP 40 according to the present embodiment includes the scanning electrode 5 that has a floating-state transparent electrode piece 5A, a branch electrode 5B, a bus electrode 5C, a connection electrode piece 5D, and a discharge gap electrode 5E. The transparent electrode piece 5A, the branch electrode 5B, and the bus electrode 5C are formed exactly the same as the first embodiment. The connecting electrode pieces 5D are transparent electrodes and are electrically connected to the branch electrodes 5B in places marked by an x in the figure. The discharge gap electrode 5E is also a transparent electrode, electrically connected to the branch electrodes 5B in places marked by an x in the figure, and is arranged parallel to the bus electrodes 5 as a common electrode shared by cells. The sustain electrode 6 is similar to the scanning electrode 5 described above, and is formed by a floating-state transparent electrode piece 6A, a branch electrode 6B, a bus electrode 6C and a connecting electrode piece 6D, and a discharge gap electrode 6E. The electrode pieces 5A, 5D, 5E and 6A, 6B, 6C are the gas discharge electrodes.

This arrangement of the discharge electrodes makes it very easy to stabilize charges within the area of the surface discharge gap 7 that controls discharge, and improve the drive stability of the PDP. Further, the connecting electrode pieces 5D, 6D of the PDP 40 have the function of increasing the uniformity and stability of discharge within the cells.

As shown in FIG. 18, the scanning electrode 5 of the PDP 50 according to the present embodiment includes a floating electrode piece 5A, a branch electrode 5B, a bus electrode 5C, a connecting electrode piece 5D, and a discharge gap electrode 5E. The transparent electrode piece 5A, the branch electrode 5B, and the bus electrode 5C are formed exactly the same as the third embodiment. The connecting electrode piece 5D is a transparent electrode, and electrically connected to the branch electrode 5B in places marked by an x in the figure. The discharge gap electrode 5E is also a transparent electrode, and is electrically connected to the branch electrode 5B in the places marked by an x in the figure. However, unlike in FIG. 17, the discharge gap electrode 5E is provided as an electrode piece in the same manner as the other electrode pieces. The sustain electrode 6 is similar in structure to the scanning electrode described above, and is also formed by a floating-state transparent electrode 6A, a branch electrode 6B, a bus electrode 6C and a connecting electrode piece 6D, and a discharge gap electrode 6E.

The effects of this case are similar to those in the PDP 40. Specifically, the discharge gap electrodes 5E, 6E stabilize the charge in an area of the surface discharge gap 7, and improve the drive stability of the PDP. The connecting electrode pieces 5D, 6D further increase the uniformity and stability of the discharge within the cells.

As mentioned in the first, second, and third embodiments, the number or shape of the electrode pieces used within this fourth embodiment may be changed as necessary. It should be noted that, in FIGS. 17 and 18, only one type of electrically connecting structure is shown where two pairs of electrode pieces composed of the electrode pieces closest to the surface discharge gap, i.e., 5E and 6E, and the electrode pieces closest to the bus electrodes, i.e., 5D and 6D, are directly electrically connected to the branch electrode. However, the present invention is not limited to the above-described structure. Specifically, any number of pairs composed of any electrode pieces including 5A, 6A may be directly electrically connected to the branch electrodes 5B, 6B.

The embodiments of the present invention have been described with reference to the accompanying drawings, but the specific structure is not limited to the embodiments described, and any modifications or alternatives that do not depart from the scope of the present invention are also incorporated herein. For example, the embodiments have been described based on the AC-type surface discharge PDP, but the present invention may be employed in the same manner to a PDP of a facing discharge type in which the discharge occurs between a gas discharge electrode provided on the front substrate and an address electrode provided on the rear substrate. Likewise, the structure combining the electrode piece of the present invention with the electrode of the prior art has been described in the fourth embodiment, but the structure of present invention may also combines the capacitance insulator structure of the present invention with a structure using a resistor.

This application is based on a Japanese patent application No. 2004-088132 which is herein incorporated by reference.

1. A plasma display panel comprising;
a first substrate including a gas discharge electrode for display covered with a dielectric layer so as to form display cells arranged in rows and columns within a display area, and a bus electrode arranged in a row direction for supplying electric power to said discharge electrode; and
a second substrate provided to face said first substrate with a discharge gas space formed between said first substrate and second substrate, including a barrier rib that divides said display cells within said display area and an address electrode arranged in a column direction,
wherein said gas discharge electrode is divided into a plurality of electrode pieces on the same plane and at least some of said electrode pieces are individually electrically coupled to said bus electrode through a capacitance insulator or resistor.

2. The plasma display panel according to claim 1, wherein said gas discharge electrode is divided to form said electrode pieces arranged in the column direction.

3. The plasma display panel according to claim 1, wherein two or more of said electrode pieces are electrically coupled with said bus electrode through said capacitance insulator or resistor.

4. The plasma display panel according to claim 1, wherein said gas discharge electrode for display is formed by a pair of surface discharge electrodes that carry out gas discharge within the discharge gas space of said display cells.

5. The plasma display panel according to claim 4, wherein at least one of said pair of surface discharge electrodes is divided into said electrode pieces.

6. The plasma display panel according to claim 4, wherein at least one pair of the electrode pieces among said electrode pieces of the surface discharge electrodes are directly electrically connected to said bus electrode.

7. The plasma display panel according to claim 6, wherein the electrode pieces opposed to each other via the surface discharge gap of said pair of surface discharge electrodes are formed of a transparent conductive material, and are connected in the row direction within the display area.

8. The plasma display panel according to claim 1, wherein some of said electrode pieces are formed of transparent conductive material.

9. The display panel according to claim 1, wherein the electrical coupling between said electrode pieces and said bus electrode is formed in an area of said display cells where no gas discharge occurs.

10. The plasma display panel according to claim 9, wherein said electrical coupling between said electrode pieces and said bus electrode is formed through a branch electrode connected to said bus electrode and arranged in a position overlapping a pattern of said barrier ribs.

11. The plasma display panel according to claim 1, wherein the electric coupling of said electrode pieces and said bus electrode is formed through a branch electrode formed of a transparent conductive material and connected to said bus electrode.

12. The plasma display panel according to claim 10, wherein said capacitance insulator is provided on a side facing the second substrate of said electrode pieces and said branch electrode is arranged so as to overlap with a part of said electrode piece via the capacitance insulator.

13. The plasma display panel according to claim 10, wherein said capacitance insulator is formed on a side facing the second substrate of said branch electrode and said electrode pieces are so arranged as to overlap with the branch electrodes via said capacitance insulator.

14. The plasma display panel according to claim 1, wherein said capacitance insulator is made from an oxide or a nitride.

15. The plasma display panel according to claim 1, wherein said resistor is made from a transparent oxide resistance material.

16. The plasma display panel according to claim 1, wherein the discharge gas filled in said discharge gas space includes at last one of Xe, Kr, Ar, or N2, and the partial pressure thereof is 100 hPa or higher.

17. The plasma display panel according to claim 1, wherein an electrode piece nearest the bus electrode is wider than another electrode piece among the plurality of the electrode pieces electrically connected to the bus electrode.

18. The plasma display panel according to claim 1, wherein the plurality of the electrode pieces electrically connected to the bus electrode have the same dimension.

19. The plasma display panel according to claim 1, wherein the capacitance insulator is thinner than the dielectric layer.
